(19) United States
(12) Patent Application Publication
(10) Pub. No.: US 2026/0036890 A1
(43) Pub. Date: Feb. 5, 2026

(54) Multilens Projection Device

(71) Applicant: Preston Rentz, Boerne, TX (US)

(72) Inventor: Preston Rentz, Boerne, TX (US)

(21) Appl. No.: 19/284,352

(22) Filed: Jul. 29, 2025

Related U.S. Application Data
(60) Provisional application No. 63/677,042, filed on Jul. 30, 2024.

(51) Int. Cl. G03B 21/14; G03B 21/16; G03B 21/20; H04N 9/31

(52) U.S. Cl. CPC G03B 21/145; G03B 21/16; G03B 21/2033; H04N 9/3147; H04N 9/3179

(57) ABSTRACT

A multi-lens projection device designed to project images and video content in multiple directions simultaneously from a single housing unit. The device comprises a housing structure with multiple lateral side panels, each equipped with projection lenses and laser-based light emitters. Unlike conventional projectors designed for screen projection, this device is specifically engineered to project onto textured wall surfaces to create immersive environments and display authentic-looking artwork reproductions. The system includes independent light emitters that can project different content through separate lenses simultaneously, computer processing capabilities with multi-lens coordination software for content management, and advanced cooling systems to support multiple simultaneous projections. Applications include residential art display, commercial entertainment venues, educational immersive environments, and architectural visualization.

### CROSS REFERENCES TO RELATED APPLICATION

Not applicable.

### FEDERALLY SPONSORED RESEARCH OR DEVELOPMENT

Not applicable.

### BACKGROUND OF THE INVENTION

### 1. Field of the Invention

This invention relates to projection systems for displaying images and video content on multiple surfaces simultaneously. This invention improves upon existing projection technology by enabling multiple directional projections from a single housing unit.

### 2. Description of the Related Art

In recent years, projection systems have become more affordable and smaller. This has led to many using multiple projectors in a space to accomplish the task of projecting multiple images on different walls or surfaces as well as to display art in new and creative ways. While this accomplishes the task of multiple projections it requires multiple devices, power sources, mounting structures, and increased power consumption.

The closest solution to this problem is an old one, the planetarium projector or star projector uses many lens projecting images to create the desired effect. The result is a bulky, oversized, system that consumes a tremendous amount of energy, needs special equipment which takes up a large area, and cannot be mounted due to its weight.

Current projection technology has been used for many years for things such as aiding teachers to show students images, showing films at a movie theater or home, for planetariums to project the night sky and stars, and more recently to display images of art in museums. As the technology has advanced the price of projection systems has reduced which has allowed users to buy multiple projection systems. Interactive art exhibits, theatre productions, and many others have used multiple projectors to create unique scenes for their customer.

The demand for more efficient and cost-effective projecting capabilities has been increasing, particularly for applications where images need to be projected onto walls rather than traditional screens, and where textured surfaces are used to enhance the authenticity of projected artwork and photographs.

### SUMMARY OF THE INVENTION

The present invention was developed to address the problems discussed above. A multi-lens projection device that enables simultaneous projection of images and video content in multiple directions from a single housing unit. The device comprises a housing structure with multiple lateral side panels, each equipped with projection lenses and associated light emitters. Unlike conventional projectors designed for screen projection, this device is specifically designed to project onto wall surfaces and textured surfaces to create immersive environments.

The invention solves the long-felt need to project imagery in multiple directions while having the ability to project different images in each direction from a single device. The system can project photos of paintings and artwork onto walls or multiple walls for life-like presentation, as well as various photographs, drawings, video content, and audio that covers entire walls or all walls to create specific themed environments within any given room.

In some embodiments, the device uses advanced laser projection technology with three-chip laser light sources that provide superior color accuracy, brightness range, and longevity compared to traditional lamp-based projectors. Each light emitter can operate independently, allowing for different content to be projected through different lenses simultaneously, or the same content can be projected through all lenses for panoramic displays.

### BRIEF DESCRIPTION OF THE SEVERAL VIEWS OF THE DRAWINGS

For an improved understanding of the present invention, and the advantages thereof, reference is made to the following descriptions taken in conjunction with the accompanying drawings. The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a diagram illustrating the underlying technology necessary for an image to pass through the device and through an individual lens for projection.

FIG. 2 is a top view of one embodiment of the invention showing a projector casing having four lenses each positioned along one of the sides of the casing.

FIG. 3 is a front side view of the embodiment shown in FIG. 2.

FIG. 4 is a top cutaway view of the embodiment shown in FIG. 2 and FIG. 3.

FIG. 5 is a perspective view of the embodiment shown in FIG. 2 and FIG. 3 and FIG. 4 in a room.

FIG. 6 is a top view of an alternative embodiment of the invention showing a projector casing having six lenses each positioned along one of the sides of the casing.

FIG. 7 is a front side view of the embodiment shown in FIG. 6.

### DETAILED DESCRIPTION OF THE INVENTION

### 1. General Considerations

The present invention disclosure is for a multi-lens projection device capable of projecting images and video content in multiple directions simultaneously. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### 2. Considerations Specific to the Invention

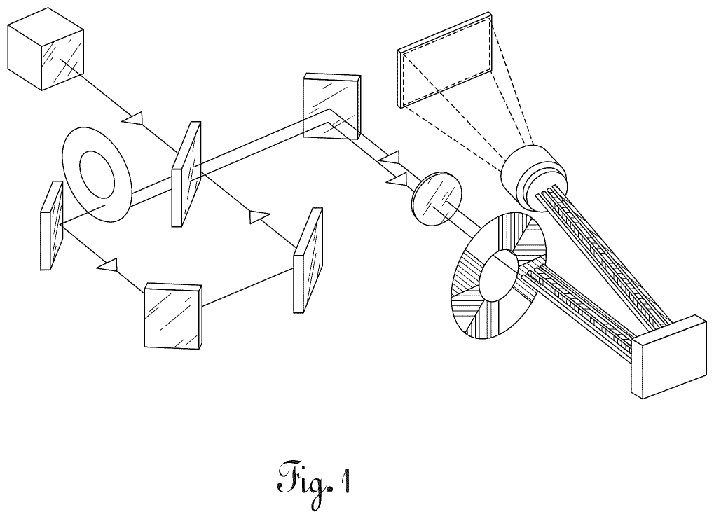

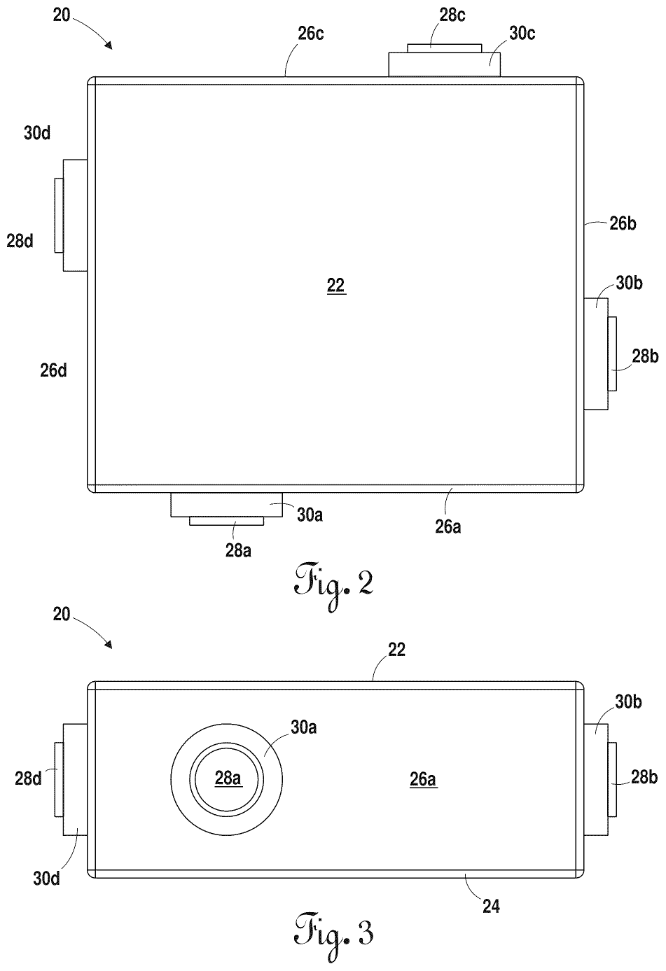

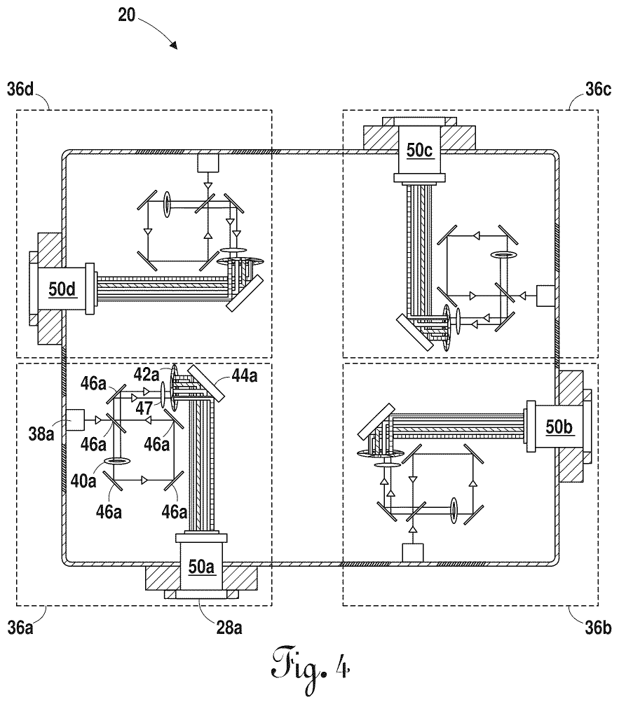

FIG. 1 is a diagram illustrating the underlying light emitter technology incorporated into some embodiments of the present invention. Where incorporated, embodiments will consist of two or more light emitter assemblies (the embodiment illustrated in FIG. 1, FIG. 2, FIG. 3, and FIG. 4 features four such light emitter assemblies). As shown here, a light emitter assembly frequently involves an optical path starting with a blue laser light source, through mirrors, one or more phosphor wheels, one or more color wheels, one or more focusing lenses, and a DLP chip. These components combined to facilitate the passage of an image through a projection lens.

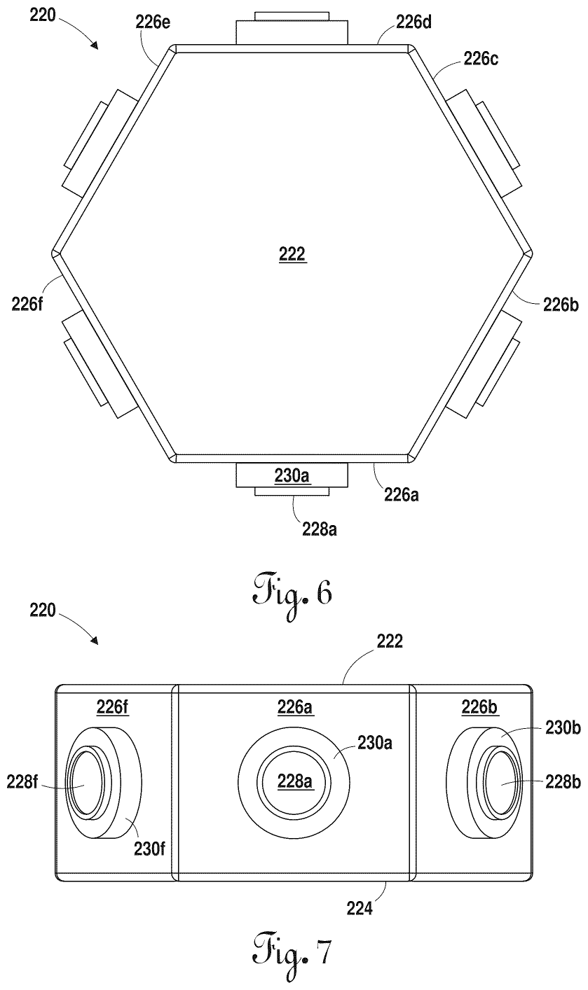

FIG. 2, FIG. 3, and FIG. 4 illustrate a multi-lens projection device 20 designed to project images and video content onto wall surfaces 116a, 116b, 116c, 116d and textured surfaces in multiple directions simultaneously. The device 20 includes a housing structure with a top side 22, bottom side 24, and multiple lateral side panels 26a, 26b, 26c, 26d (in a four-sided embodiment). Alternatively embodiments, such as the embodiment shown in FIG. 6 and FIG. 7 illustrate an embodiment of the invention having six sides 226a, 226b, 226c, 226d, 226e, 226f. Unlike conventional projectors that are designed to project onto screens, the multi-lens projector 20 is intended to project onto textured wall surfaces that enhance the appearance and authenticity of projected artwork, photographs, and immersive content. In some embodiments, the multi-lens projector is able to project images of original paintings onto surfaces that are specifically designed to receive/reflect that given image's original texture, or method that was used to create the painting originally. For instance, if the image of a painting is of a classic oil, the texture will be applied on a wall or panel with an oil-like texture. Same for paintings that have the dry brush look, or one that has the palette knife texture, sponge or dragging look, scraping look, or even a mixture of textures. There's even an “under-painting” look, which is not unusual for paintings of antiquity. These textures can all be duplicated, and customized on a person's wall, or portable panels can be pre-manufactured with a specific texture, and shipped to the client. One may collect various textured panels overtime in order to change out as needed, just as one would change out one painting for another.

In some embodiments, the device 20 uses multiple three-chip laser projector systems, with each light emitter 36a, 36b, 36c, 36d comprising a blue laser light source 38a, 38b, 38c, 38d. Each blue laser light is emitted through a series of mirrors 46a, 46b, 46c, 46d then adds yellow by running it through a phosphor wheel 40a, 40b, 40c, 40d, which also helps to generate an image through Digital Light Processing via DLP chip 44a, 44b, 44c, 44d. The system then uses filter assemblies to break up the yellow into green and red components. The laser light continues to run through the series of mirrors 46a, 46b, 46c, 46d, through color wheel 42a, 42b, 42c, 42d and then the DLP chip 44a, 44b, 44c, 44d and then into the final projection lens assembly 50a, 50b, 50c, 50d for output through primary projection lens 28a, 28b, 28c, 28d. By the time the original blue laser light reaches the final projection lens 28a, 28b, 28c, 28d, it has created multiple laser colors of blue, green and red, and is able to project its given image with great color brilliance, detail and accuracy onto the target wall surface 116a.

In this embodiment, the device 20 includes multiple independent light emitters 36a, 36b, 36c, 36d, each capable of projecting different content through separate lenses 28a, 28b, 28c, 28d. Each individual projected image 118a, 118b, 118c, 118d coming from the multi-lens projector 20 has its own light emitting mechanism 36a, 36b, 36c, 36d and optical processing pathway. The light emitting mechanism is supported by a computer processor and image processing software that identifies and communicates to each emitter 36a, 36b, 36c, 36d uniquely as to what content it will project.

In this embodiment, the housing structure comprises multiple lateral side panels 26a, 26b, 26c, 26d, with each side panel containing at least one projection lens 28a, 28b, 28c, 28d positioned within a lens housing 30a, 30b, 30c, 30d. In preferred embodiments, the device 20 may have four lateral side panels 26a, 26b, 26c, 26d with four lenses 28a, 28b, 28c, 28d arranged to project in cardinal directions. The alternative embodiment shown in FIG. 6 and FIG. 7 comprises six lateral side panels 226a, 226b, 226c, 226d, 226e, 226f with six lenses 228a, 228b, 228c, 228d, 228e, 228f for hexagonal projection coverage. The number of side panels and lenses can be varied to accommodate different spatial requirements and applications within the installation room 115.

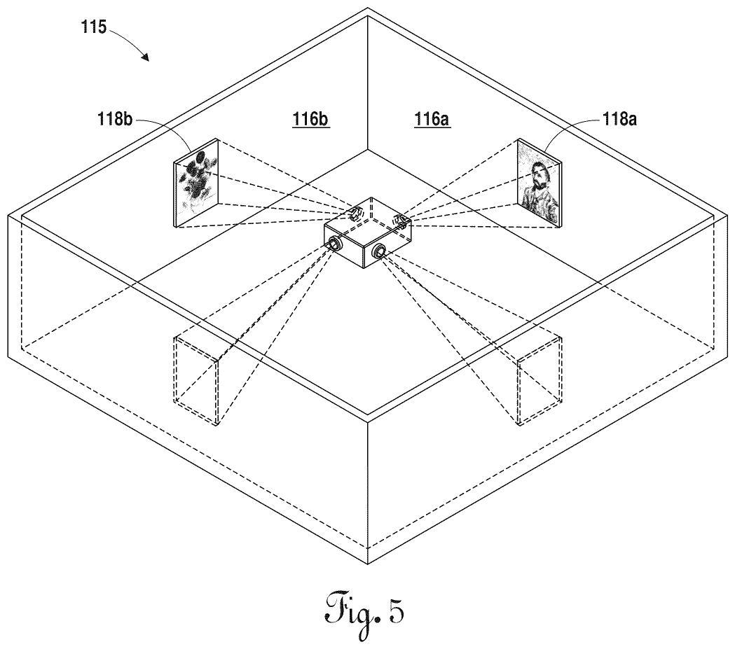

The computer processor is coupled to memory/storage unit and main circuit board, and works in conjunction with image storage and processing software to manage content delivery to each light emitter 36a, 36b, 36c, 36d. The multi-lens coordination software ensures that different images can be projected simultaneously through different lenses 28a, 28b, 28c, 28d, or that the same content can be synchronized across all lenses for panoramic displays. Color calibration system and keystone correction system help optimize image quality for each projection surface 116a, 116b, 116c, 116d (FIG. 5).

Power source provides electrical power through power input connector and distributes power via power distribution board and internal power cables. The voltage regulation circuitry and power management system ensure stable operation of multiple simultaneous light emitters 36a, 36b, 36c, 36d. In typical embodiments, the device 20 operates on 100-300 watts total power consumption, allowing multiple laser projection systems to operate simultaneously within the capacity of a standard 110V household outlet.

The selection of laser-based light sources in the multi-lens projection device 20 provides significant advantages over traditional lamp-based and LED projection technologies. Laser projectors deliver exceptional brightness levels and clarity, making them ideal for projecting onto wall surfaces in rooms with varying ambient light conditions. The laser light sources offer superior longevity, with operational lifespans typically ranging from 30,000 to 40,000 hours, which is substantially longer than traditional lamp-based projectors that require bulb replacement every 2,000 to 5,000 hours. This extended lifespan significantly reduces maintenance requirements and operational costs over the lifetime of the device, while ensuring consistent performance across all projection lenses.

Additionally, the laser technology provides superior contrast ratios and vibrant color reproduction through the interaction of the blue laser light sources with the phosphor wheels, creating saturated and dynamic colors that are essential for authentic reproduction of artwork and photographs on textured surfaces. The sealed optical engines of the laser-based light emitters require minimal maintenance compared to lamp-based systems, reducing downtime and associated costs. The precision and stability of laser light sources also enable the multi-lens coordination software to maintain consistent color calibration across all projection paths, ensuring that synchronized content displays maintain uniform quality whether projecting the same image through all lenses or different content through each lens independently.

Despite the high-performance capabilities of laser technology, the laser-based light sources generate significantly less heat compared to traditional high-intensity lamp projectors, reducing the overall thermal load on the cooling system, if any. The improved thermal efficiency of laser technology is particularly advantageous in the multi-lens configuration, where multiple light emitters operate simultaneously, as the cumulative heat generation remains manageable within the capacity of a cooling system, if any, without requiring oversized or excessively noisy cooling components.

FIG. 5 illustrates a perspective view of the embodiment shown in FIG. 2, FIG. 3 and FIG. 4 installed in a room 115, showing projected images 118a, 118b, 118c, 118d on wall surfaces 116a, 116b, 116c, 116d. The present invention may apply to residential environments where users want to display high-quality reproductions of paintings and artwork on their wall surfaces 116a, 116b, 116c, 116d having textured panels, commercial spaces such as retail stores and entertainment venues requiring immersive displays, educational environments including museums and classrooms where immersive historical or thematic content can transform the entire room 115, architectural visualization where full-size 4D renderings can be projected on surrounding walls, and convention spaces where 360-degree presentations can be created from the single device 20.

This application has presented several embodiments of the present invention and discussed various devices, such as the four-sided rectangular housing embodiment with lateral side panels 26a, 26b, 26c, 26d and corresponding lenses 28a, 28b, 28c, 28d, the hexagonal housing variant 220 with six side panels 226a, 226b, 226c, 226d, 226e, 226f and six lenses 228a, 228b, 228c, 228d, 228e, 228f, laser-based light emitting systems 36a, 36b, 36c, 36d with blue laser sources 38a-38d. Some embodiments feature computer processor with image processing capabilities, cooling systems including fans and liquid cooling, power management systems capable of handling multiple simultaneous projections, and lens focusing mechanisms that allow for manual or electronic adjustment of projection direction, etc.

It is contemplated that components/and devices embodying the invention may exist in varying arrangements, combinations, and still reflect the spirit of the present invention. The present invention may be incorporated into other assemblies, which may have modular lens assemblies, upgrade ports, scalable power modules, portable mounting systems, and advanced connectivity through wireless communication module.

In alternative embodiments, the device 20 may include different numbers of lenses 28a, 28b, 28c, 28d relative to the number of lateral side panels 26a, 26b, 26c, 26d, with some embodiments having fewer lenses than side panels or more lenses than side panels depending on the specific application requirements. The hexagonal housing variant 220 demonstrates scalability to six-sided projection, and the modular design allows for upgrade capabilities through upgrade port and scalable power module to accommodate future enhancements.

The present invention is described above in terms of a preferred illustrative embodiment in which a specifically described multi-lens projection device with laser-based light emitters, multiple independent projection paths through lenses, textured surface compatibility with surfaces, computer processor with multi-lens coordination software, advanced cooling system, and comprehensive mounting options are described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

Alternative embodiments may use an LED projector or a lamp projector instead of a laser projector described herein—or a combination of laser, LED, and lamp.

Alternative embodiments may use alternative chips such as LCD and LCOS chips instead of or in addition to DLP chips.

In some embodiments, each lens includes a lens adjustment mechanism that allows for manual or electronic adjustment of projection direction and focus.

As mentioned, some embodiments feature a cooling system that includes primary cooling fans for intake and exhaust, ambient liquid cooling system, heat sink assemblies, and thermal management sensors. Ventilation grilles allow proper airflow throughout the housing. The cooling system is designed to handle the thermal load of multiple simultaneous laser light sources and associated electronics while maintaining quiet operation suitable for residential and commercial environments.

Some embodiments include wireless communication module for Wi-Fi and Bluetooth connectivity, allowing the device 20 to receive content from external devices through mobile app interface module. External connection ports provide wired connectivity options, while control interface and remote control receiver allow for local operation and control.

In some embodiments, the device includes ceiling mount attachment point for mounting to a ceiling location, or wall mount bracket interface for alternative mounting configurations. An internal support frame, component mounting brackets, and cable management system provide structural integrity and organized internal layout.

### 3. Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating immersive multi-directional projection environments using advanced laser projection technology with textured surface compatibility, coordinated through computer processor and multi-lens coordination software, with thermal management via cooling system, and flexible mounting options through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

We claim:

1. A multi-lens projection device comprising:
a housing structure having a top side;
a bottom side;
a first lateral side panel;
a second lateral side panel;
a first lens positioned within a first lens housing on the first lateral side panel;
a second lens positioned within a second lens housing on the second lateral side panel;
at least one light emitter configured to emit light as a replication of an image through the first lens and the second lens.

2. The multi-lens projection device of claim 1 further comprising a computer processor configured to store and process imagery into projectable images.

3. The multi-lens projection device of claim 2, wherein the computer processor includes multi-lens coordination software configured to simultaneously control multiple light emitters to project different images through different lenses.

4. The multi-lens projection device of claim 1 further comprising a cooling device.

5. The multi-lens projection device of claim 4, wherein the cooling device comprises at least one cooling fan and an ambient liquid cooling system for thermal management of multiple simultaneous projections.

6. The multi-lens projection device of claim 1 further comprising a blue laser light source, a phosphor wheel, a color wheel, and a DLP chip.

7. The multi-lens projection device of claim 1, wherein the housing structure comprises four lateral side panels arranged in a rectangular configuration, each lateral side panel having at least one lens.

8. The multi-lens projection device of claim 1, wherein the housing structure comprises a hexagonal housing with six lateral side panels, each lateral side panel having at least one lens.

9. The multi-lens projection device of claim 1, further comprising multiple independent light emitters, a plurality of lenses equal in number to the number of light emitters, each light emitter corresponding to a different lens.

10. The multi-lens projection device of claim 9 capable of projecting different content simultaneously.

11. The multi-lens projection device of claim 9, wherein each light emitter includes a blue laser light source, one more mirrors, and a projection lens.

12. The multi-lens projection device of claim 1, wherein each lens includes a lens adjustment mechanism allowing for manual or electronic adjustment of projection direction.

13. The multi-lens projection device of claim 1, wherein the device is configured to project images onto textured wall surfaces.

14. The multi-lens projection device of claim 1, further comprising a wireless communication module for receiving content from external devices.
